(19) United States
(12) Patent Application Publication
(10) Pub. No.: US 2026/0221531 A1
(43) Pub. Date: Jul. 30, 2026

(54) RECOVERY METHOD, METHOD FOR PRODUCING ELECTRODE, AND RECOVERY SYSTEM

(71) Applicant: KABUSHIKI KAISHA TOYOTA CHUO KENKYUSHO, Nagakute-shi, Aichi-ken (JP)

(72) Inventor: Nobuhiro OGIHARA, Nagakute-shi (JP)

(73) Assignee: KABUSHIKI KAISHA TOYOTA CHUO KENKYUSHO, Nagakute-shi, Aichi-ken (JP)

(21) Appl. No.: 19/145,273

(22) PCT Filed: Oct. 20, 2023
(86) PCT No.: PCT/JP2023/037959

§ 371 Date: Jul. 2, 2025

(30) Foreign Application Priority Data
Jan. 23, 2023 (JP) 2023-008046

(51) Int. Cl. H01M 10/54; H01M 4/02; H01M 4/505; H01M 4/525; H01M 10/0525

(52) U.S. Cl. CPC H01M 10/54; H01M 4/505; H01M 4/525; H01M 2004/028; H01M 10/0525

(57) ABSTRACT

A recovery method for recovering an electrode active material from a treatment target electrode including an electrode mixture containing the electrode active material and a binder. The recovery method includes a separation step of bringing a first treatment liquid containing an aromatic hydrocarbon compound in a reduced state and a metal ion and a second treatment liquid containing water into contact with the treatment target electrode to separate the electrode active material from the treatment target electrode.

### TECHNICAL FIELD

This Description discloses a recovery method, a method for producing an electrode, and a recovery system.

### BACKGROUND ART

As a method for recycling an electrode, hitherto, there has been proposed a method including recovering an active material powder from an electrode, performing a regeneration treatment that is either hydrothermal treatment with short-time annealing or solid-state synthesis, and converting the regenerated electrode material into a slurry for use in the production of new batteries (for example, NPL 1).

### CITATION LIST

### Non Patent Literature

NPL 1: Green Chem., 2018, 20, 851-862

### SUMMARY OF INVENTION

### Technical Problem

However, separation and recovery of an active material powder from an electrode have not been sufficiently considered, and it has been desired to more easily separate and recover an active material from an electrode.

The present disclosure has been made in view of the above problem, and a primary object of the present disclosure is to provide a novel recovery method, method for producing an electrode, and recovery system that can more easily separate and recover an active material from an electrode.

### Solution to Problem

As a result of extensive studies to achieve the above object, the present inventors have found that bringing a predetermined first treatment liquid and a second treatment liquid containing water into contact with an electrode enables an active material to be more easily separated and recovered and have completed the present disclosure.

Specifically, a recovery method disclosed in this Description is
a recovery method for recovering an electrode active material from a treatment target electrode including an electrode mixture containing the electrode active material and a binder, the recovery method including:
a separation step of bringing a first treatment liquid containing an aromatic hydrocarbon compound in a reduced state and a metal ion and a second treatment liquid containing water into contact with the treatment target electrode to separate the electrode active material from the treatment target electrode.

A method for producing an electrode according to the present disclosure includes
an electrode preparation step of preparing a new electrode using the electrode active material recovered by the above recovery method.

A recovery system according to the present disclosure is
a recovery system for recovering an electrode active material from a treatment target electrode including an electrode mixture containing the electrode active material and a binder, the recovery system including:
a separation unit configured to perform a separation treatment including bringing a first treatment liquid containing an aromatic hydrocarbon compound in a reduced state and a metal ion and a second treatment liquid containing water into contact with the treatment target electrode to separate the electrode active material from the treatment target electrode.

### Advantageous Effects of Invention

The recovery method, the method for producing an electrode, and the recovery system according to the present disclosure can more easily separate and recover an active material from an electrode. The reason for achieving this advantageous effect is considered as follows. For example, the first treatment liquid containing an aromatic hydrocarbon compound in a reduced state and a metal ion donates electrons to a binder such as a fluorine-containing polymer to thereby cause carbonization of the binder to proceed and reduce binding ability at the same time. Furthermore, the second treatment liquid containing water promotes this reaction of reducing the binding ability. This enables an electrode active material to be easily separated and recovered from a treatment target electrode.

### BRIEF DESCRIPTION OF DRAWINGS

FIG. 1 is an explanatory view illustrating an example of a recovery system 50 and a separation treatment.

FIG. 2 is an explanatory view illustrating an example of the state of a treatment target electrode 10 in the separation treatment.

FIG. 3 illustrates reaction formulas related to the reduction of a binder, etc. by Li-Naph.

FIG. 4 illustrates a reaction formula related to a reaction of Li-Naph with water.

FIG. 5 includes XRD patterns of powders obtained in separation steps of Experimental Examples 1 to 6.

FIG. 6 includes XRD patterns of powders obtained in separation steps of Experimental Examples 7 to 10.

FIG. 7 includes XRD patterns of powders obtained in separation steps of Experimental Examples 11 to 16.

FIG. 8 includes XRD patterns of powders obtained in separation steps of Experimental Examples 17 to 22.

FIG. 9 includes XRD patterns of powders obtained in separation steps of Experimental Examples 45 to 50.

FIG. 10 is an XRD pattern of a powder obtained in a separation step of Experimental Example 51.

FIG. 11 shows peaks of a 003 plane of LiNi_{1/3}Co_{1/3}Mn_{1/3}O₂ in the XRD patterns of the powders obtained in the separation steps of Experimental Examples 1 to 22.

FIG. 12 shows peaks of a 111 plane of LiFePO₄ in the XRD patterns of the powders obtained in the separation steps of Experimental Examples 45 to 50.

### DESCRIPTION OF EMBODIMENTS

A recovery method, a method for producing an electrode, and a recovery system according to the present disclosure relate to an electrode for an electricity storage device. Examples of the electricity storage device include hybrid capacitors, pseudo-electric double layer capacitors, secondary batteries of an alkali metal such as lithium or sodium, alkali metal ion batteries, and air batteries. Examples of a metal ion serving as a carrier ion include alkali metal ions, such as Li, Na, and K ions, and group 2 ions (alkaline-earth metal ions), such as Mg, Ca, and Sr ions. Of these, a lithium ion is preferred. Of these, the electricity storage device is preferably a lithium secondary battery, in particular, a lithium-ion secondary battery. Herein, a description will be mainly given on the assumption that the electricity storage device is a lithium secondary battery. The electricity storage device may include, for example, a positive electrode having a positive electrode active material for occluding and releasing lithium ions, a negative electrode having a negative electrode active material for occluding and releasing lithium ions, and an electrolyte solution that is located between the positive electrode and the negative electrode and that conducts lithium ions. The electricity storage device may include a separator between the positive electrode and the negative electrode.

The positive electrode may include a positive electrode mixture containing a positive electrode active material and a binder. The positive electrode mixture may be formed on the surface of a current collector. The positive electrode mixture may contain an electrically conductive material and the like in addition to the positive electrode active material and the binder. The positive electrode may be formed by, for example, mixing a positive electrode active material, a binder, and, as needed, an electrically conductive material together, adding an appropriate solvent thereto to prepare a paste-like positive electrode mixture, applying the positive electrode mixture to the surface of a current collector, subsequently performing drying, and optionally performing compression in order to increase the electrode density. Examples of the positive electrode active material include compounds containing lithium and a transition metal element, and oxides containing lithium and a transition metal element are preferred. The positive electrode active material that can be used is, for example, a lithium manganese composite oxide represented by a basic composition formula such as Li₍₁₋ₓ₎MnO₂ (for example, 0<x<1, the same applies to the following) or Li₍₁₋ₓ₎Mn₂O₄, a lithium cobalt composite oxide represented by a basic composition formula such as Li₍₁₋ₓ₎CoO₂, a lithium nickel composite oxide represented by a basic composition formula such as Li₍₁₋ₓ₎NiO₂, or a lithium nickel cobalt manganese composite oxide represented by a basic composition formula such as Li₍₁₋ₓ₎NiₐCo_{b}Mn_{c}O₂ (a+b+c=1). Alternatively, the positive electrode active material may be lithium iron phosphate. Note that the term “basic composition formula” means that another element may be contained.

The binder functions to bind active material particles and electrically conductive material particles together. For example, fluorine-containing resins such as polytetrafluoroethylene (PTFE), polyvinylidene fluoride (PVdF), and fluororubbers; thermoplastic resins such as polypropylene and polyethylene; ethylene-propylene-diene monomer (EPDM) rubber; sulfonated EPDM rubber; and natural butyl rubber (NBR) can be used alone or as a mixture of two or more thereof. It is also possible to use an aqueous dispersion of cellulose-based carboxymethylcellulose (CMC), a styrene-butadiene copolymer (SBR), polyvinyl alcohol, or the like, which is water-based binder.

The electrically conductive material is not particularly limited as long as it is an electron-conductive material that does not adversely affect the battery performance. For example, carbon materials such as graphite, e.g., natural graphite (vein graphite and flake graphite) and synthetic graphite, acetylene black, carbon black, Ketjenblack, carbon whiskers, needle coke, and carbon fibers; and metals (such as copper, nickel, aluminum, silver, and gold) can be used alone or as a mixture of two or more thereof. Examples of usable solvents for dispersing the positive electrode active material, the electrically conductive material, and the binder include organic solvents such as N-methylpyrrolidone, dimethylformamide, dimethylacetamide, methyl ethyl ketone, cyclohexanone, methyl acetate, methyl acrylate, diethylenetriamine, N,N-dimethylaminopropylamine, ethylene oxide, and tetrahydrofuran. The active material may be prepared in the form of a slurry with a latex of SBR or the like by adding a dispersant, a thickener, and the like to water. Examples of the thickener include polysaccharides such as carboxymethylcellulose and methylcellulose, which can be used alone or as a mixture of two or more. Examples of coating methods include roller coating using an applicator roller or the like, screen coating, a doctor blade method, spin coating, and coating with a bar coater, any of which can be used to provide any thickness and shape. Examples of current collectors that can be used include aluminum, titanium, stainless steel, nickel, iron, baked carbon, electrically conductive polymers, conductive glass, and current collectors formed by subjecting aluminum, copper, or the like to surface treatment with carbon, nickel, titanium, silver, or the like for the purpose of improving adhesion, conductivity, and oxidation resistance. These current collectors can also be subjected to surface oxidation treatment. Examples of the shape of current collectors include a foil shape, a film shape, a sheet shape, a net shape, a punched or expanded shape, a lath body, a porous body, a foamed body, and a formed body of a group of fibers. The current collector used has a thickness of, for example, 1 to 500 μm.

The negative electrode may include a negative electrode mixture containing a negative electrode active material and a binder. The negative electrode mixture may be formed on the surface of a current collector. The negative electrode mixture may contain an electrically conductive material and the like in addition to the negative electrode active material and the binder. The negative electrode may be formed by, for example, mixing a negative electrode active material, a binder, and, as needed, an electrically conductive material together, adding an appropriate solvent to prepare a paste-like negative electrode mixture, applying the negative electrode mixture to the surface of a current collector, subsequently performing drying, and optionally performing compression in order to increase the electrode density. Examples of the negative electrode active material include inorganic compounds such as lithium, lithium alloys, and tin compounds; carbon materials capable of occluding and releasing lithium ions; composite oxides containing a plurality of elements; and electrically conductive polymers. Examples of the carbon material include cokes, glassy carbons, graphites, non-graphitizable carbons, pyrolytic carbons, and carbon fibers. Examples of the composite oxide include lithium titanium composite oxides and lithium vanadium composite oxides. As the binder, the electrically conductive material, the solvent, the coating method, and the current collector for the negative electrode, for example, one or more of those described as examples in the positive electrode can be used.

The electrolyte solution may be, for example, an electrolyte solution in which a supporting salt is dissolved. Examples of the supporting salt include lithium salts such as LiPF₆ or LiBF₄. Examples of solvents of the electrolyte solution include carbonates, esters, ethers, nitriles, furans, sulfolanes, and dioxolanes, which can be used alone or as a mixture. Specific examples of the carbonates include cyclic carbonates such as ethylene carbonate (EC), propylene carbonate (PC), vinylene carbonate (VC), butylene carbonate, and chloroethylene carbonate; and chain carbonates such as dimethyl carbonate (DMC), ethyl methyl carbonate (EMC), diethyl carbonate, ethyl-n-butyl carbonate, methyl-t-butyl carbonate, di-i-propyl carbonate, and t-butyl-1-propyl carbonate. The electrolyte solution used may be a solid ion-conducting polymer, an inorganic solid electrolyte, a mixed material of an organic polymer electrolyte and an inorganic solid electrolyte, or an inorganic solid powder bound by an organic binder.

### [Recovery Method]

A recovery method according to the present disclosure is a method for recovering an electrode active material from a treatment target electrode including an electrode mixture containing the electrode active material and a binder. The recovery method includes a separation step of bringing a first treatment liquid and a second treatment liquid into contact with the treatment target electrode to separate the electrode active material from the treatment target electrode. The method for treating an electrode may be performed under conditions in which destruction of the crystal structure of the electrode active material before and after the separation step is suppressed.

### (Treatment Target Electrode)

The treatment target electrode may be the positive electrode or the negative electrode of the electricity storage device described above but is preferably a positive electrode. The treatment target electrode is preferably an oxide containing a metal ion of the same type as a metal ion contained in the first treatment liquid described later, preferably a lithium transition metal composite oxide, more preferably a composite oxide containing lithium, nickel, manganese, and cobalt or a composite oxide containing lithium and iron. The binder contained in the treatment target electrode preferably contains a fluorine-containing polymer (fluorine-containing resin) such as polyvinylidene fluoride. The treatment target electrode may be a new one, for example, remnants remaining in the production process of an electrode or a used one. In this treatment target electrode, the electrode active material is preferably in a state of capable of occluding and releasing carrier ions, and is preferably one that is not deactivated.

### (Treatment Liquids)

The first treatment liquid contains an aromatic hydrocarbon compound in a reduced state and a metal ion. The first treatment liquid may contain at least one of aromatic hydrocarbon compounds represented by formulas (1) and (2) below. The first treatment liquid be obtained by at least one of formulas (3) and (4) below. Specifically, a metal may be caused to react with an aromatic hydrocarbon compound, so that an aromatic hydrocarbon compound in a reduced state and a metal ion are contained. The metal preferably has high reactivity so as to react with the aromatic hydrocarbon compound and is preferably, for example, an alkali metal or a metal of a group 2 element. The first treatment liquid may contain an aromatic hydrocarbon compound that is at least one of naphthalene, biphenyl, o-terphenyl, anthracene, and p-terphenyl. The aromatic hydrocarbon compound is preferably naphthalene or biphenyl. The first treatment liquid may contain a metal ion that is at least one of a lithium ion, a sodium ion, and a potassium ion. Of these metal ions, a lithium ion is more preferred.

The first treatment liquid may contain a first solvent that is an ether compound. The first solvent may be, for example, a cyclic ether compound or a chain ether compound. The first solvent may be at least one of tetrahydrofuran (THF), dioxolane (DOL), dioxane (DOX), diethyl ether (DEE), dimethoxyethane (DME), diglyme (G2), triglyme (G3), and tetraglyme (G4). Of these, DME and THF are more preferred, and DME is still more preferred. For example, as shown in formulas (5) to (7), the first treatment liquid is preferably prepared by causing Li metal to react with one of naphthalene, biphenyl, and o-terphenyl in DME serving as the first solvent. The use of such a first treatment liquid facilitates the separation of an electrode active material from an electrode and also suppresses the destruction of the crystal structure of the electrode active material at that time.

In the first treatment liquid, the concentration of the aromatic hydrocarbon compound in the reduced state with respect to the entire first treatment liquid may be 0.05 mol/L or more, 0.1 mol/L or more, 0.15 mol/L or more, or 0.20 mol/L or more from the viewpoint of more reliably separating the electrode active material from the treatment target electrode. This concentration may be 2 mol/L or less, 1 mol/L or less, or 0.5 mol/L or less from the viewpoints of reducing the amount of aromatic hydrocarbon compound in the reduced state used and suppressing the destruction of the crystal structure of the electrode active material.

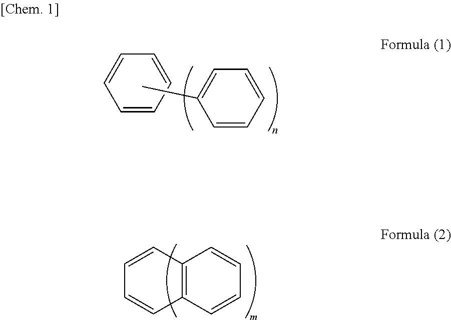

In the formulas, n is an integer of 1 or more and 4 or less, m is an integer of 1 or more and 4 or less, and these aromatic rings may each have a substituent or a heteroatom in its structure.

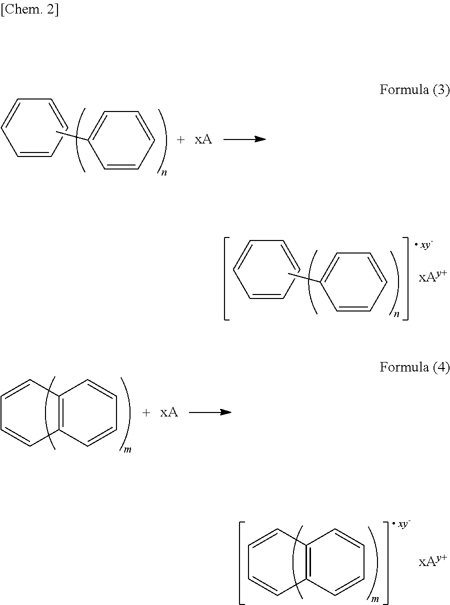

In the formulas, n is an integer of 1 or more and 4 or less, m is an integer of 1 or more and 4 or less, and these aromatic rings may each have a substituent or a heteroatom in its structure. x and y are each any number, and A is a metal.

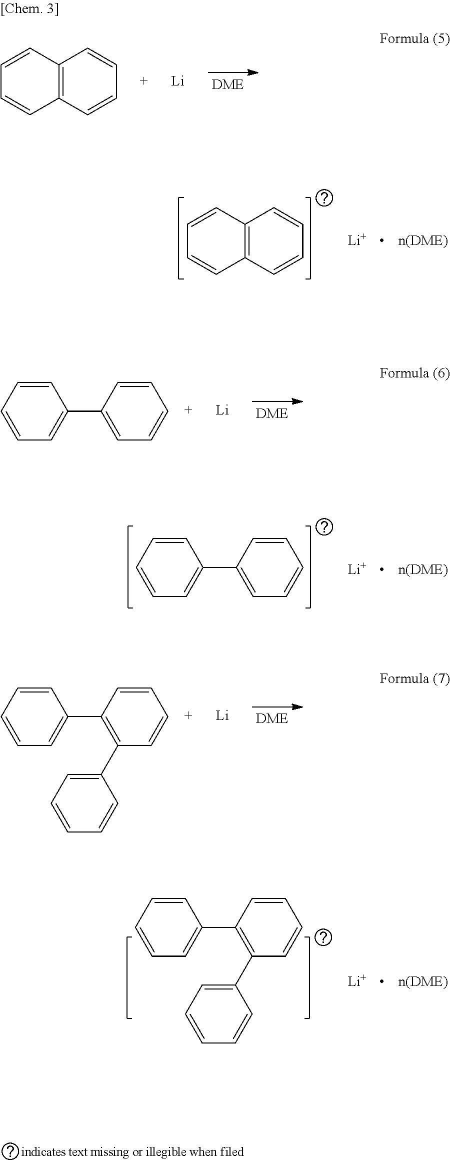

The first treatment liquid is considered to have a function of donating an electron to the binder and thereby causing carbonization of the binder to proceed and simultaneously reducing binding ability. The first treatment liquid may have a function of donating an electron and a carrier ion to an electrode active material and thereby recovering the capacity of the treatment target electrode whose capacity has degraded.

The first treatment liquid may contain, as a second solvent, a solvent used for the electrolyte solution of the electricity storage device. Examples of the second solvent include those described as examples of the solvent of the electrolyte solution in the electricity storage device described above. Presumably, the first treatment liquid is either a brown liquid or a dark green liquid and has different reducing powers depending on whether or not the first treatment liquid contains the second solvent. As the content of the second solvent decreases, the reducing power increases, and as the content of the second solvent increases, the reducing power becomes mild. Accordingly, whether or not to add the second solvent and the amount of second solvent added can be determined as appropriate depending on the desired reducing power.

It is only necessary that the second treatment liquid contain water, but the second treatment liquid preferably has a higher water content. The second treatment liquid may contain water in an amount of 50% by mass or more, may contain water in an amount of 80% by mass or more, or may contain water in an amount of 90% by mass or more. The second treatment liquid may be water.

### (Separation Step)

In the separation step, a separation treatment including bringing the first treatment liquid and the second treatment liquid into contact with the treatment target electrode is performed. In the separation step, for example, a first treatment in which the first treatment liquid is brought into contact with the treatment target electrode and a second treatment in which the second treatment liquid is brought into contact with the treatment target electrode may be performed. In the separation step, the second treatment liquid may be brought into contact with the treatment target electrode in a state where the first treatment liquid is brought into contact with the treatment target electrode. Hereinafter, a description will be mainly given of a case where, in the separation step, in the state where the first treatment liquid is in contact with the treatment target electrode through the first treatment, the second treatment liquid is brought into contact with the treatment target electrode by the second treatment.

In the first treatment, the treatment target electrode is brought into contact with the first treatment liquid. This first treatment is considered to reduce the binding force of the binder of the treatment target electrode. The method for bringing the first treatment liquid into contact with the treatment target electrode is not particularly limited, and may be, for example, a method in which the treatment target electrode is immersed in the first treatment liquid or a method in which the first treatment liquid is applied to the treatment target electrode by spraying, dripping, or the like. In the first treatment, the treatment target electrode may be immersed in the first treatment liquid under stirring. The treatment time during which the first treatment is performed is not particularly limited, but may be, for example, 10 seconds or more, one minute or more, two minutes or more, or five minutes or more from the viewpoint of fully distributing the first treatment liquid to the binder inside the treatment target electrode. The treatment time during which the first treatment is performed may be, for example, 1 hour or less, 30 minutes or less, 20 minutes or less, or 15 minutes or less from the viewpoints of reducing the treatment time and suppressing the destruction of the crystal structure of the electrode active material. Note that, in the case where the first treatment is immersion, this treatment time may be the immersion time. The treatment time may be the time since the treatment target electrode comes in contact with the first treatment liquid until the treatment target electrode comes in contact with the second treatment liquid. In the first treatment, the amount of first treatment liquid used is not particularly limited but may be, for example, more than or equal to 0.1 times, more than or equal to 0.2 times, or more than or equal to 0.5 times the mass of the electrode mixture from the viewpoint of fully distributing the first treatment liquid to the binder inside the treatment target electrode. The amount of first treatment liquid used may be, for example, less than or equal to 10 times, less than or equal to 5 times, or less than or equal to 3 times the mass of the electrode mixture from the viewpoint of, for example, reducing the amount of aromatic hydrocarbon compound used. In the first treatment, it is preferable to use a first treatment liquid having a concentration of the aromatic hydrocarbon compound in the reduced state of 0.5 mol/L or less. The lower the concentration of the aromatic hydrocarbon compound in the reduced state, the milder the reducing power of the first treatment liquid becomes, and the more effectively the destruction of the crystal structure of the electrode active material, etc. can be suppressed. The treatment temperature during the first treatment is not particularly limited but may be, for example, in a range of 10° C. or higher and 60° C. or lower, or in a range of 20° C. or higher and 40° C. or lower. The treatment temperature is preferably around room temperature (20° C. to 25° C.). In the first treatment, for example, by filtering the used first treatment liquid, unnecessary first treatment liquid may be removed from the treatment target electrode after the first treatment and from a powder containing the electrode active material.

In the second treatment, the second treatment liquid is brought into contact with the treatment target electrode in a state of being in contact with the first treatment liquid due to the first treatment. This second treatment is considered to further reduce the binding force of the binder of the treatment target electrode. The method for bringing the second treatment liquid into contact with the treatment target electrode is not particularly limited, and may be, for example, a method in which the treatment target electrode is immersed in the second treatment liquid or a method in which the second treatment liquid is applied to the treatment target electrode by spraying, dripping, or the like. In the second treatment, the treatment target electrode may be immersed in the second treatment liquid under stirring. The treatment time during which the second treatment is performed is not particularly limited, but may be, for example, 10 seconds or more, one minute or more, or two minutes or more from the viewpoint of fully distributing the second treatment liquid to the binder inside the treatment target electrode. The treatment time during which the second treatment is performed may be, for example, 1 hour or less, 30 minutes or less, 15 minutes or less, or 5 minutes or less from the viewpoint of reducing the treatment time. Note that, in the case where the second treatment is immersion, this treatment time may be the immersion time. The treatment time may be the time since the treatment target electrode comes in contact with the second treatment liquid until removal of the second treatment liquid is started. In the second treatment, the amount of second treatment liquid used is not particularly limited but may be, for example, more than or equal to 0.1 times, more than or equal to 0.2 times, or more than or equal to 0.5 times the mass of the electrode mixture from the viewpoint of fully distributing the second treatment liquid to the binder inside the treatment target electrode. The amount of second treatment liquid used may be, for example, less than or equal to 10 times, less than or equal to 5 times, or less than or equal to 3 times the mass of the electrode mixture. The treatment temperature during the second treatment is not particularly limited but may be, for example, in a range of 10° C. or higher and 60° C. or lower, or in a range of 20° C. or higher and 40° C. or lower. The treatment temperature is preferably around room temperature (20° C. to 25° C.). In the second treatment, for example, by filtering the used second treatment liquid, unnecessary second treatment liquid may be removed from the treatment target electrode after the second treatment and from a powder containing the electrode active material.

The separation step may include, after the first treatment and the second treatment, solvent washing in which at least one of the treatment target electrode and the powder containing the electrode active material is washed with a washing liquid containing a solvent that can dissolve the aromatic hydrocarbon compound. Through this solvent washing, the aromatic hydrocarbon compound due to the first treatment liquid and the like are removed. Examples of the solvent that can dissolve the aromatic hydrocarbon compound include the ether compounds described above. The solvent used in the washing liquid may be the same as or different from the ether compound contained in the first treatment liquid.

The separation step may include, after the first treatment and the second treatment, water washing in which at least one of the treatment target electrode and the powder containing the electrode active material is washed with washing water containing water. It is considered that, through this water washing, a metal ion due to the first treatment liquid and the like can be removed.

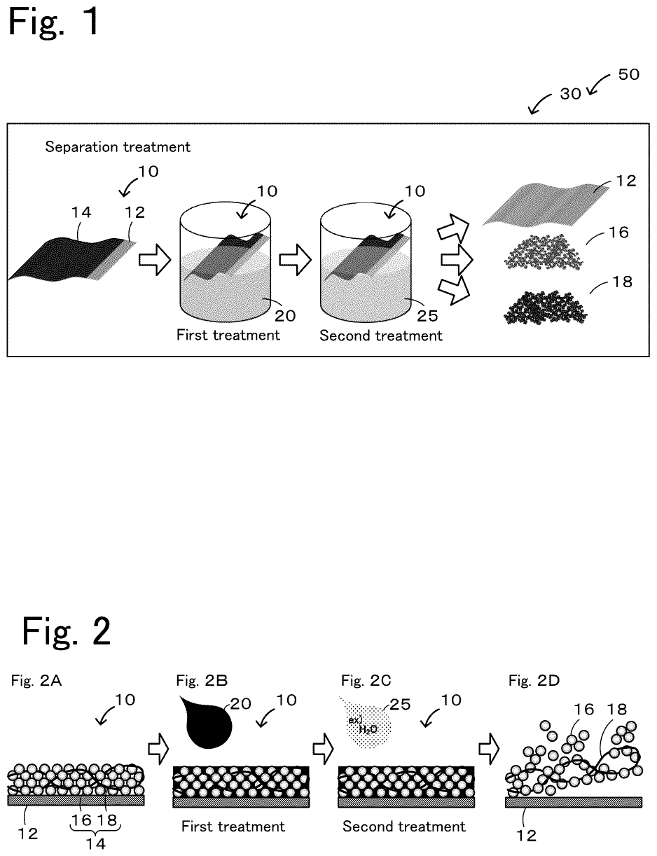

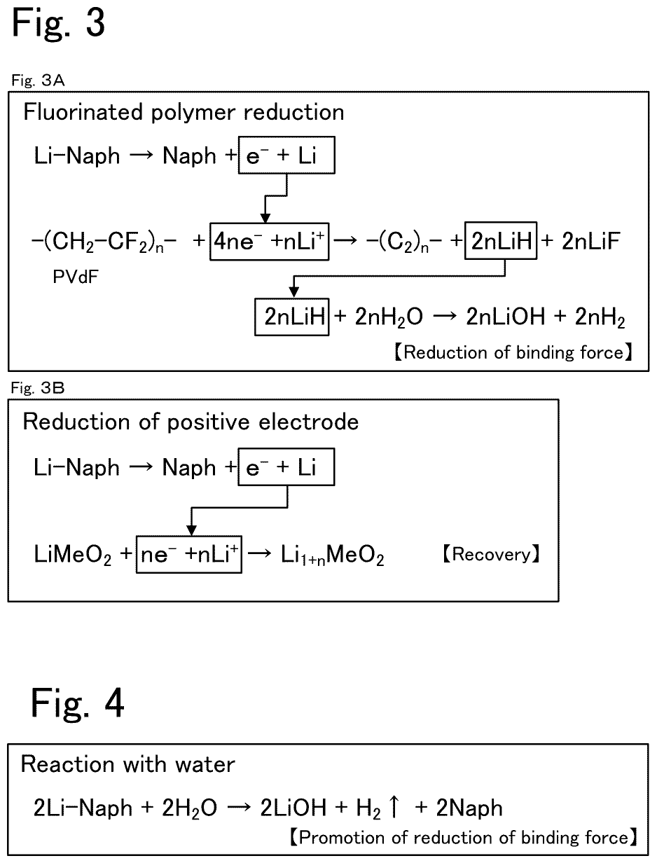

In this separation step, an electrode active material can be separated from a treatment target electrode only by bringing the first treatment liquid containing an aromatic hydrocarbon compound in a reduced state and a metal ion and the second treatment liquid containing water into contact with the treatment target electrode including an electrode mixture containing the electrode active material and a binder. For example, as illustrated in FIGS. 1 and 2, when the first treatment in which a treatment target electrode 10 is brought into contact with a first treatment liquid 20 is performed, the reactions illustrated in FIG. 3A proceed, and the binding force of a binder contained in a positive electrode mixture 14 decreases. Furthermore, when the second treatment in which the treatment target electrode 10 in contact with the first treatment liquid 20 is brought into contact with a second treatment liquid 25 is performed, the reaction illustrated in FIG. 4 proceeds, and the decrease in the binding force of the binder contained in the positive electrode mixture 14 is promoted. As a result, the treatment target electrode 10 is decomposed into a current collector 12, an electrode active material 16, and a mixture member 18. The mixture member 18 contains, for example, components of an electrically conductive material and a binder other than a positive electrode active material. Thus, in the separation step, the electrode active material can be separated from the treatment target electrode. Note that the treatment target electrode 10 may be decomposed into the current collector 12, the electrode active material 16, and the mixture member 18 only by the first treatment depending on the conditions for the first treatment; however, by performing the second treatment, the treatment target electrode 10 can be decomposed into the current collector 12, seven if the first treatment is performed under milder conditions. Thus, the amount of aromatic hydrocarbon compound used and the treatment time can be reduced, and the electrode active material can be efficiently separated from the treatment target electrode. In addition, performing the first treatment under milder conditions also further suppresses the destruction of the crystal structure of the electrode active material 16 due to the first treatment and thus is preferable.

In this separation step, the capacity of a treatment target electrode whose capacity has degraded may be recovered. For example, when the treatment target electrode 10 whose capacity has degraded is subjected to the first treatment described above, in addition to the reactions illustrated in FIG. 3A, the reactions illustrated in FIG. 3B proceed to recover the charge-discharge activity of the positive electrode active material. By utilizing this, in the separation step, the electrode active material is separated from the treatment target electrode, and the capacity of the electrode active material can be recovered at the same time.

In this recovery method, for example, the degree of degradation of the treatment target electrode may be determined, and whether the electrode active material is separated from the treatment target electrode and recovered or the electrode active material is recovered in the state of the electrode without being separated may be switched depending on the result. For example, if the treatment target electrode is degraded to the extent that reuse in the state of the electrode is impossible, the electrode active material separated from the treatment target electrode in the above-described separation step may be recovered. If the degree of degradation is such that reuse in the state of the electrode is possible, in the separation step described above, the first treatment is performed to recover the capacity, the second treatment is omitted, and the electrode active material whose capacity has recovered may be recovered without being separated from the treatment target electrode. This enables the electrode active material to be recovered in a more appropriate state depending on the degree of degradation of the treatment target electrode. The degree of degradation of the treatment target electrode may be determined, for example, by using an electricity storage device before the treatment target electrode is taken out, may be defined, for example, by the ratio of the capacity after degradation to the initial capacity or the like, or may be estimated on the basis of the alternating-current impedance.

For the electrode active material recovered by this recovery method, in an XRD pattern obtained by X-ray diffraction (XRD) measurement, a peak intensity I at 2θ where the peak intensity becomes the maximum intensity I₀ when an unused electrode active material is measured is preferably more than or equal to 0.2 times the maximum intensity I₀. This peak intensity I is preferably more than or equal to 0.5 times, more preferably more than or equal to 0.7 times the maximum intensity I₀. This peak intensity I is considered to be I₀ or less, but a larger value thereof is preferred because the destruction of the crystal structure of the active material is considered to be more effectively suppressed. For example, the peak with the maximum intensity I₀ may be a peak of a 003 plane (2θ=18.7°) in the case where the electrode active material is LiNi_{1/3}Co_{1/3}Mn_{1/3}O₂ or may be a peak of a 111 plane (2θ=25.6°) in the case where the electrode active material is LiFePO₄.

### [Method for Producing Electrode]

A method for producing an electrode according to the present disclosure includes an electrode preparation step of preparing a new electrode using an electrode active material separated from the treatment target electrode by the above-described method for treating an electrode. In the electrode preparation step, an electrode mixture obtained by mixing the electrode active material, and as needed, a binder, and an electrically conductive material together may be applied to a current collector to prepare an electrode. In the method for producing an electrode, as the binder, the electrically conductive material, the solvent, the coating method, and the current collector, for example, one or more of those described as examples in the positive electrode can be used.

### [Recovery System]

A recovery system according to the present disclosure is a recovery system for recovering an electrode active material from a treatment target electrode including an electrode mixture containing the electrode active material and a binder. The recovery system includes a separation unit configured to perform a separation treatment including bringing a first treatment liquid and a second treatment liquid into contact with the treatment target electrode to separate the electrode active material from the treatment target electrode. A recovery system 50 in FIG. 1 is an example of this recovery system and includes a separation unit 30.

The separation unit 30 is equipment or an apparatus for separating an electrode active material 16 from a treatment target electrode 10. In this separation unit 30, a first treatment liquid 20 and a second treatment liquid 25 are brought into contact with the treatment target electrode 10 to separate the electrode active material 16 from the treatment target electrode 10. In the recovery system 50, the separation unit 30 is configured so that the first treatment liquid 20 is brought into contact with the treatment target electrode 10 by the first treatment, and, in this state, the second treatment liquid 25 is then brought into contact with the treatment target electrode 10 by the second treatment to separate the electrode active material 16 from the treatment target electrode 10. In the separation unit 30, for example, the treatment described in the above separation step may be performed.

The recovery system 50 may include, for example, a controller that is not illustrated and that controls the entire recovery system 50. The recovery system may include a determination unit that is not illustrated and that determines the degree of degradation of the treatment target electrode. In the recovery system 50, for example, the controller may control the determination unit to determine the degree of degradation of the treatment target electrode 10 and may control the separation unit 30 according to the result to switch whether the electrode active material 16 is separated from the treatment target electrode 10 and recovered or the electrode active material 16 is recovered in the state of the electrode without being separated. The determination unit may be configured to perform determination using an electricity storage device before the treatment target electrode 10 is taken out, for example, may be configured to determine the degree of degradation on the basis of the capacity or may be configured to estimate the degree of degradation on the basis of the alternating-current impedance.

The recovery method, the method for producing an electrode, and the recovery system according to the present embodiment described above can more easily separate and recover an active material from an electrode. The reason for achieving this advantageous effect is considered as follows. For example, the first treatment liquid containing an aromatic hydrocarbon compound in a reduced state and a metal ion donates electrons to a binder such as a fluorine-containing polymer to thereby cause carbonization of the binder to proceed and reduce binding ability at the same time. Furthermore, the second treatment liquid containing water promotes the reaction of reducing the binding ability. This enables an electrode active material to be easily separated and recovered from a treatment target electrode. Note that the electrode active material may be separated from the treatment target electrode only by the first treatment depending on the conditions for the first treatment; however, by performing the second treatment, the electrode active material is separated from the treatment target electrode even if the first treatment is performed under milder conditions. Thus, the amount of aromatic hydrocarbon compound used and the treatment time can be reduced, and the electrode active material can be efficiently separated and recovered from the treatment target electrode. In addition, performing the first treatment under milder conditions also further suppresses the destruction of the crystal structure of the active material due to the first treatment and thus is preferable.

It goes without saying that the present disclosure is not limited to the embodiment described above and can be implemented in various aspects without departing from the technical scope of the present disclosure. For example, in the embodiment described above, in the case where a used electrode is used as the treatment target electrode, an introduction step of introducing a metal ion serving as a carrier ion into the electrode active material may be performed before the separation step, after the separation step, after the electrode preparation step, or the like.

The present disclosure may be any one of [1] to [10] below.

[1] A recovery method for recovering an electrode active material from a treatment target electrode including an electrode mixture containing the electrode active material and a binder, the recovery method including:
a separation step of bringing a first treatment liquid containing an aromatic hydrocarbon compound in a reduced state and a metal ion and a second treatment liquid containing water into contact with the treatment target electrode to separate the electrode active material from the treatment target electrode.

[2] The recovery method according to [1], wherein, in the separation step, the second treatment liquid is brought into contact with the treatment target electrode in a state where the first treatment liquid is in contact with the treatment target electrode.

[3] The recovery method according to [1] or [2], wherein, in the separation step, the first treatment liquid used has a concentration of the aromatic hydrocarbon compound in the reduced state of 0.1 mol/L or more and 0.5 mol/L or less.

[4] The recovery method according to any one of [1] to [3], wherein, in the separation step, a contact time during which the treatment target electrode is brought into contact with the first treatment liquid is 1 minute or more and 20 minutes or less.

[5] The recovery method according to any one of [1] to [4], wherein the binder contains a fluorine-containing polymer.

[6] The recovery method according to any one of [1] to [5], wherein the electrode active material is an oxide containing the metal ion.

[7] The recovery method according to any one of [1] to [6], wherein the aromatic hydrocarbon compound is at least one of compounds represented by formulas (1) and (2):

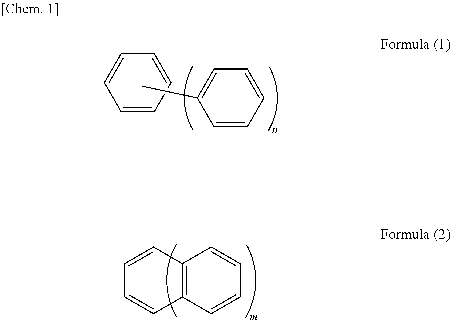

In the formulas, n is an integer of 1 or more and 4 or less, m is an integer of 1 or more and 4 or less, and these aromatic rings may each have a substituent or a heteroatom in its structure.

[8] The recovery method according to any one of [1] to [7], wherein the first treatment liquid contains at least one of dimethoxyethane (DME), tetrahydrofuran (THF), diethyl ether (DEE), diglyme (G2), triglyme (G3), and tetraglyme (G4).

[9] A method for producing an electrode, including:
an electrode preparation step of preparing a new electrode using the electrode active material recovered by the recovery method according to any one of [1] to [8].

[10] A recovery system for recovering an electrode active material from a treatment target electrode including an electrode mixture containing the electrode active material and a binder, the recovery system including:
a separation unit configured to perform a separation treatment including bringing a first treatment liquid containing an aromatic hydrocarbon compound in a reduced state and a metal ion and a second treatment liquid containing water into contact with the treatment target electrode to separate the electrode active material from the treatment target electrode.

### EXAMPLES

Hereinafter, examples in which a method for treating an electrode according to the present disclosure is specifically studied will be described as experimental examples. Experimental Examples 1 to 22 and 45 to 53 correspond to Examples of the present disclosure, and Experimental Examples 23 to 44 correspond to Reference Examples.

### Experimental Examples 1 to 6

(Treatment target electrode)

A positive electrode mixture containing 92% by mass of LiNi_{1/3}Co_{1/3}Mn_{1/3}O₂ (NCM, manufactured by Toda Kogyo Corp.) serving as a positive electrode active material, 5% by mass of acetylene black (manufactured by Denka Company Limited) serving as an electrically conductive material, and 3% by mass of polyvinylidene difluoride (manufactured by Kureha Corporation) serving as a binder was applied to one surface of an aluminum current collector foil at a mass per unit area of 7 mg/cm² to prepare an electrode, which was used as a treatment target electrode.

### (Treatment Liquids)

Naphthalene was dissolved at 1.00 mol/L in a 1,2-dimethoxyethane (DME) solvent in an inert atmosphere, lithium metal was then added so as to have the same concentration as the concentration of naphthalene, and stirring was performed to prepare a dark green anion radical liquid composition having a lithium naphthalenide (Li-Naph) concentration of 1.00 mol/L by a reaction represented by the formula (5). The prepared anion radical liquid composition was used as a first treatment liquid. Water was used as a second treatment liquid.

### (Separation Step)

In 10 mL (about 10 g) of the prepared first treatment liquid, 20 cm² of the treatment target electrode was added and immersed, and stirring was performed for 5 minutes in Experimental Example 1, for 10 minutes in Experimental Example 2, for 15 minutes in Experimental Example 3, for 30 minutes in Experimental Example 4, for 45 minutes in Experimental Example 5, and for 60 minutes in Experimental Example 6 (first treatment). Subsequently, the first treatment liquid and the electrode mixture peeled off from the treatment target electrode were transferred from a container to a funnel, and suction filtration was performed using a vacuum pump. Next, water was added to the container in which the treatment target electrode remained, and stirring was performed to wash the treatment target electrode with water (second treatment). Subsequently, the water and the electrode mixture peeled off from the treatment target electrode were transferred from the container to the funnel, and suction filtration was performed. Subsequently, the same water washing as above and solvent washing using THF instead of water were alternately repeated. The water washing after the second treatment was performed for the purpose of removing remaining lithium ions, and the solvent washing was performed for the purpose of removing remaining naphthalene. Thus, the treatment target electrode (current collector foil) from which the electrode mixture had been peeled off and a powder (electrode active material) separated from the treatment target electrode were obtained.

### (Evaluation of Peeled State)

The treatment target electrode from which the electrode mixture had been peeled off was visually checked to roughly evaluate the percentage of a portion where the electrode mixture had been peeled off. The results are shown in Table 1. In the evaluation, the case where the electrode mixture had almost completely peeled off was rated as “A”, the case where about 50% of the electrode mixture had peeled off was rated as “B”, and the case where about 20% of the electrode mixture had peeled off was rated as “C”.

### (Evaluation of Crystal State)

The obtained powder was vacuum-dried a 120° C. and then subjected to X-ray diffraction (XRD) measurement using an X-ray diffractometer (Ultima IV, manufactured by Rigaku Corporation) to check the crystal structure. The XRD measurement was performed using CuKα (wavelength: 1.54051 Å), at an accelerating voltage of 40 kV, with a current of 30 mA, at a sampling width of 0.020°/min and a scanning speed of 5° min⁻¹, and in an angle range of 15° to 50° (2θ). The crystal state was evaluated on the basis of the obtained XRD pattern. The results are shown in Table 1. In the evaluation, in the case where the peak (2θ=18.7°) of a 003 plane of LiNi_{1/3}Co_{1/3}Mn_{1/3}O₂ was found, it was determined that the destruction of the crystal structure was suppressed and this case was rated as “A”. In the case where the peak of a 003 plane of LiNi_{1/3}Co_{1/3}Mn_{1/3}O₂ was not found, it was determined that the destruction of the crystal structure occurred and this case was rated as “B”. In this case, the intensity of the peak of a 003 plane of unused LiNi_{1/3}Co_{1/3}Mn_{1/3}O₂ was normalized as 1.00. In the case where the intensity of the corresponding peak of the powder of each experimental example was 0.2 or more, it was determined that the peak was found. In the case where the intensity of the corresponding peak was less than 0.2, it was determined that the peak was not found.

### Experimental Examples 7 to 22

Experimental Examples 7 to 10 were conducted as in Experimental Examples 1, 2, 5, and 6, respectively, except that the concentration of Li-Naph in the first treatment liquid was changed from 1.00 mol/L to 0.50 mol/L. Experimental Examples 11 to 16 were conducted as in Experimental Examples 1 to 6, respectively, except that the concentration of Li-Naph in the first treatment liquid was changed to 0.25 mol/L. Experimental Examples 17 to 22 were conducted as in Experimental Examples 1 to 6, respectively, except that the concentration of Li-Naph in the first treatment liquid was changed to 0.10 mol/L.

### Experimental Examples 23 to 44

Experimental Examples 23 to 44 were conducted as in Experimental Examples 1 to 22, respectively, except that, in the separation step, after the first treatment, the second treatment and water washing were omitted, and solvent washing with THF was performed.

### Experimental Examples 45 to 50

Experimental Examples 45 to 50 were conducted as in Experimental Examples 1 to 6, respectively, except that the positive electrode active material of the treatment target electrode was changed from LiNi_{1/3}Co_{1/3}Mn_{1/3}O₂ to LiFePO₄. In the evaluation of the crystal state, in the case where the peak (2θ=25.6°) of a 111 plane of LiFePO₄ was found, it was determined that the destruction of the crystal structure was suppressed and this case was rated as “A”. In the case where the peak of a 111 plane of LiFePO₄ was not found, it was determined that the destruction of the crystal structure occurred and this case was rated as “B”. In this case, the intensity of the peak of a 111 plane of unused LiFePO₄ was normalized as 1.00. In the case where the intensity of the corresponding peak of the powder of each experimental example was 0.2 or more, it was determined that the peak was found. In the case where the intensity of the corresponding peak was less than 0.2, it was determined that the peak was not found.

### Experimental Examples 51 to 53

The solvent of the first treatment liquid was changed from DME to tetrahydrofuran (THF). In the first treatment, 160 mg of the first treatment liquid was sprayed on the treatment target electrode instead of immersing the treatment target electrode in the first treatment liquid. Subsequently, the second treatment was performed in which the treatment target electrode after the spray treatment was immersed in water for one minute so that the entire treatment target electrode was immersed. Experimental Example 51 was conducted as in Experimental Example 1 except for the above. Experimental Example 52 was conducted as in Experimental Example 51 except that the amount of first treatment liquid sprayed was changed from 160 mg to 110 mg. Experimental Example 53 was conducted as in Experimental Example 51 except that the amount of first treatment liquid sprayed was changed from 160 mg to 46 mg. The mass of the positive electrode active material contained in 20 cm² of the treatment target electrode was 70 mg, and the mass of the positive electrode mixture was 76.1 mg. The ratio of the amount of first treatment liquid spayed to the mass of the positive electrode mixture was 2.1 in Experimental Example 51, 1.4 in Experimental Example 52, and 0.6 in Experimental Example 53.

### [Results and Discussion]

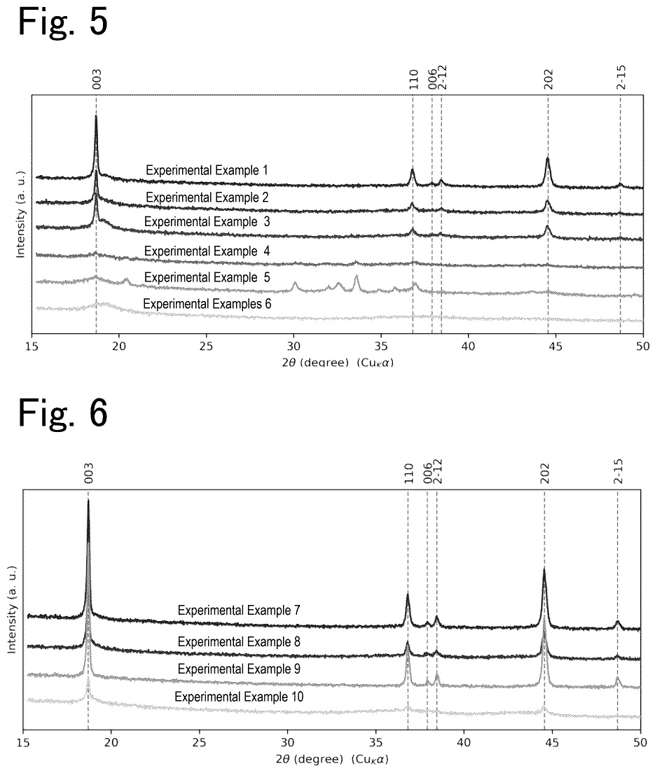

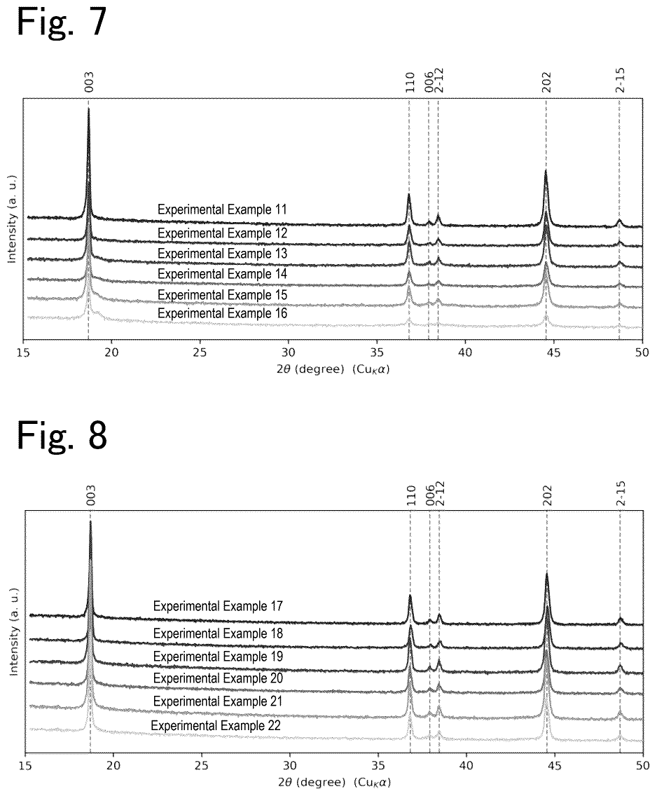

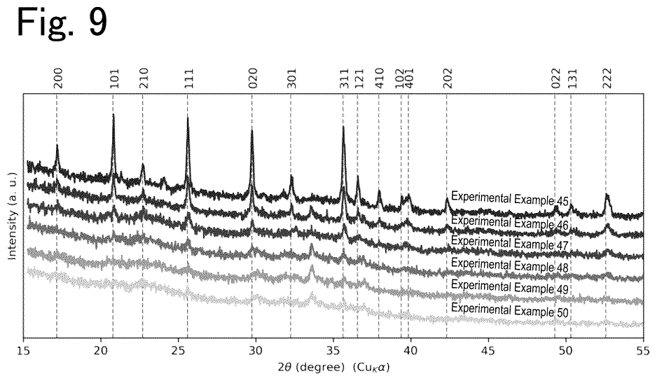

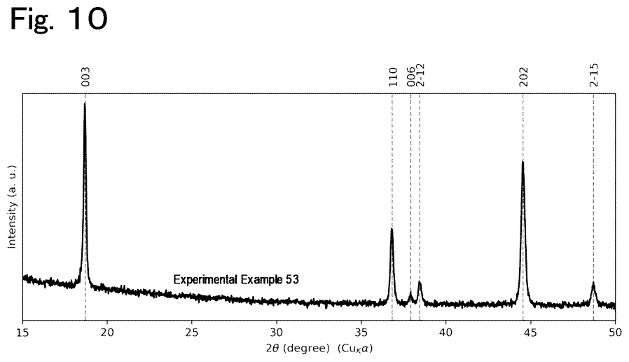

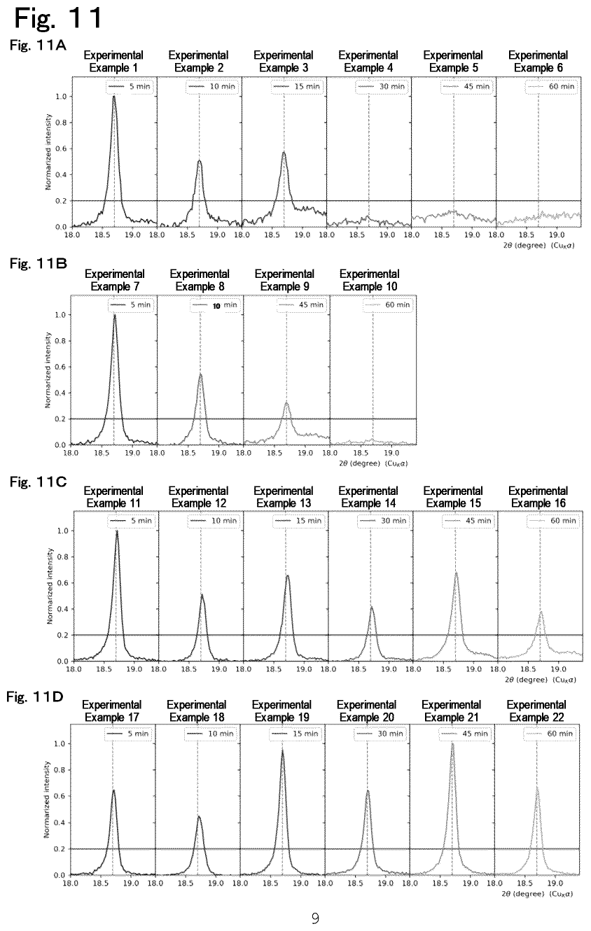

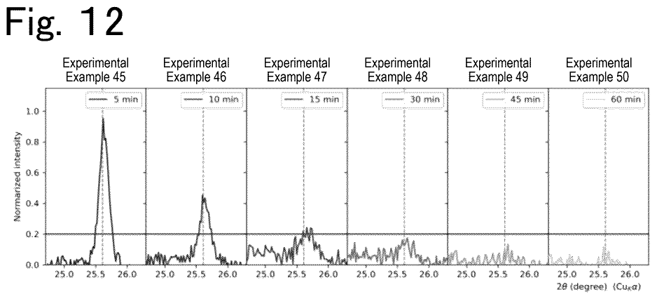

Tables 1 to 4 summarize the active material, the first treatment, the second treatment, the peeled state, and the crystal state in Experimental Examples 1 to 22, 23 to 44, 45 to 50, and 51 to 53. Table 5 summarizes the effects of the presence or absence of the second treatment, the Li-Naph concentration of the first treatment liquid, and the treatment time of the first treatment on the peeled state in Experimental Examples 1 to 44. Table 6 summarizes the effects of the Li-Naph concentration of the first treatment liquid and the treatment time of the first treatment on the crystal state in Experimental Examples 1 to 22. Table 7 summarizes the effects of the Li-Naph concentration of the first treatment liquid and the treatment time of the first treatment on the crystal state in Experimental Examples 45 to 50. FIGS. 5 to 10 show XRD patterns of the powders obtained in the separation step in Experimental Examples 1 to 6, 7 to 10, 11 to 16, 17 to 22, 45 to 50, and 51. FIG. 11 shows peaks of a 003 plane of LiNi_{1/3}Co_{1/3}Mn_{1/3}O₂ in the XRD patterns of the powders obtained in the separation step of Experimental Examples 1 to 22. FIG. 12 shows peaks of a 111 plane of LiFePO₄ in the XRD patterns of the powders obtained in the separation step of Experimental Examples 45 to 50.

As shown in Tables 1, 2, and 5, regarding Experimental Examples 1 to 44, in Experimental Examples 23 to 44, in which the second treatment was not performed, when the first treatment liquid having a Li-Naph concentration of 1.00 mol/L was used, the electrode mixture completely peeled off; however, when the first treatment liquid having a Li-Naph concentration of 0.50 mol/L was used, about 50% of the electrode mixture peeled off, and when the first treatment liquid having a Li-Naph concentration of 0.25 mol/L or less was used, only about 20% of the electrode mixture peeled off. On the other hand, in each of Experimental Examples 1 to 22, in which the second treatment was performed, the electrode mixture completely peeled off, and it was found that the electrode active material could be more easily separated from the treatment target electrode. This demonstrated that the electrode active material could be more easily separated by performing the second treatment. However, in Experimental Examples 17 to 22, in which the Li-Naph concentration was 0.1 mol/L, the electrode mixture peeled off not as a powder but as a flake. Accordingly, it was presumed that if the electrode active material needed to be recovered separately from the mixture member, the Li-Naph concentration was preferably more than 0.1 mol/L.

As shown in Table 3, in Experimental Examples 45 to 50, in which the second treatment was performed, the positive electrode active material was LiFePO₄, and the electrode mixture completely peeled off in each experimental example. This showed that the type of positive electrode active material was not particularly limited. As shown in Table 4, in Experimental Examples 51 to 53, in which the second treatment was performed, the first treatment was performed not by immersion but by spraying, and the electrode mixture completely peeled off in each experimental example. This showed that the method for bringing the treatment target electrode into contact with the first treatment liquid was not particularly limited. Similarly, it was presumed that the method for bringing the treatment target electrode into contact with the second treatment liquid was also not particularly limited.

Tables 1, 2, 6, and 7 showed that the lower the Li-Naph concentration of the first treatment liquid and the shorter the treatment time of the first treatment, the less likely the destruction of the crystal structure is to occur, and the more suitable it is for recycling, which is preferred. From these viewpoints, it was found that the concentration of Li-Naph was preferably, for example, 0.5 mol/L or less. It was also found that the treatment time of the first treatment was preferably 20 minutes or less.

TABLE 1

| | | First treatment | | | | | | |
|---|---|---|---|---|---|---|---|---|
| | | Treatment | Li-Naph | Method for | Treatment | Second | 1) Peeled | 2) Crystal |
| Experimental | Electrode | liquid | conc. | treating | time | treatment | state | state |
| Examples | — | — | mol/L | — | min. | — | — | — |
| 1 | LiNi_{1/3}Co1_{/3}Mn_{1/3}O₂ | Li-Naph/DME | 1.00 | Immersion | 5 | Water | A | A |
| | | | | | | washing | | |
| 2 | LiNi_{1/3}Co1_{/3}Mn_{1/3}O₂ | Li-Naph/DME | 1.00 | Immersion | 10 | Water | A | A |
| | | | | | | washing | | |
| 3 | LiNi_{1/3}Co1_{/3}Mn_{1/3}O₂ | Li-Naph/DME | 1.00 | Immersion | 15 | Water | A | A |
| | | | | | | washing | | |
| 4 | LiNi_{1/3}Co1_{/3}Mn_{1/3}O₂ | Li-Naph/DME | 1.00 | Immersion | 30 | Water | A | B |
| | | | | | | washing | | |
| 5 | LiNi_{1/3}Co1_{/3}Mn_{1/3}O₂ | Li-Naph/DME | 1.00 | Immersion | 45 | Water | A | B |
| | | | | | | washing | | |
| 6 | LiNi_{1/3}Co1_{/3}Mn_{1/3}O₂ | Li-Naph/DME | 1.00 | Immersion | 60 | Water | A | B |
| | | | | | | washing | | |
| 7 | LiNi_{1/3}Co1_{/3}Mn_{1/3}O₂ | Li-Naph/DME | 0.50 | Immersion | 5 | Water | A | A |
| | | | | | | washing | | |
| 8 | LiNi_{1/3}Co1_{/3}Mn_{1/3}O₂ | Li-Naph/DME | 0.50 | Immersion | 10 | Water | A | A |
| | | | | | | washing | | |
| 9 | LiNi_{1/3}Co1_{/3}Mn_{1/3}O₂ | Li-Naph/DME | 0.50 | Immersion | 45 | Water | A | A |
| | | | | | | washing | | |
| 10 | LiNi_{1/3}Co1_{/3}Mn_{1/3}O₂ | Li-Naph/DME | 0.50 | Immersion | 60 | Water | A | B |
| | | | | | | washing | | |
| 11 | LiNi_{1/3}Co1_{/3}Mn_{1/3}O₂ | Li-Naph/DME | 0.25 | Immersion | 5 | Water | A | A |
| | | | | | | washing | | |
| 12 | LiNi_{1/3}Co1_{/3}Mn_{1/3}O₂ | Li-Naph/DME | 0.25 | Immersion | 10 | Water | A | A |
| | | | | | | washing | | |
| 13 | LiNi_{1/3}Co1_{/3}Mn_{1/3}O₂ | Li-Naph/DME | 0.25 | Immersion | 15 | Water | A | A |
| | | | | | | washing | | |
| 14 | LiNi_{1/3}Co1_{/3}Mn_{1/3}O₂ | Li-Naph/DME | 0.25 | Immersion | 30 | Water | A | A |
| | | | | | | washing | | |
| 15 | LiNi_{1/3}Co1_{/3}Mn_{1/3}O₂ | Li-Naph/DME | 0.25 | Immersion | 45 | Water | A | A |
| | | | | | | washing | | |
| 16 | LiNi_{1/3}Co1_{/3}Mn_{1/3}O₂ | Li-Naph/DME | 0.25 | Immersion | 60 | Water | A | A |
| | | | | | | washing | | |
| 17 | LiNi_{1/3}Co1_{/3}Mn_{1/3}O₂ | Li-Naph/DME | 0.10 | Immersion | 5 | Water | A | A |
| | | | | | | washing | | |
| 18 | LiNi_{1/3}Co1_{/3}Mn_{1/3}O₂ | Li-Naph/DME | 0.10 | Immersion | 10 | Water | A | A |
| | | | | | | washing | | |
| 19 | LiNi_{1/3}Co1_{/3}Mn_{1/3}O₂ | Li-Naph/DME | 0.10 | Immersion | 15 | Water | A | A |
| | | | | | | washing | | |
| 20 | LiNi_{1/3}Co1_{/3}Mn_{1/3}O₂ | Li-Naph/DME | 0.10 | Immersion | 30 | Water | A | A |
| | | | | | | washing | | |
| 21 | LiNi_{1/3}Co1_{/3}Mn_{1/3}O₂ | Li-Naph/DME | 0.10 | Immersion | 45 | Water | A | A |
| | | | | | | washing | | |
| 22 | LiNi_{1/3}Co1_{/3}Mn_{1/3}O₂ | Li-Naph/DME | 0.10 | Immersion | 60 | Water | A | A |
| | | | | | | washing | | |

1) A: Complete peeling, B: 50% peeling, C: 20% peeling
2) A: The peak of a 003 plane of LiNi_{1/3}Co 1_{/3} Mn_{1/3}O₂ is found in the XRD pattern.
B: The peak of a 003 plane of LiNi_{1/3}Co 1_{/3}Mn_{1/3}O₂ is not found in the XRD pattern.

TABLE 2

| | | First treatment | | | | | | |
|---|---|---|---|---|---|---|---|---|
| | | Treatment | Li-Naph | Method for | Treatment | Second | 1) Peeled | 2) Crystal |
| Experimental | Active material | liquid | conc. | treating | time | treatment | state | state |
| Examples | — | — | mol/L | — | min. | — | — | — |
| 23 | LiNi_{1/3}Co1_{/3}Mn_{1/3}O₂ | Li-Naph/DME | 1.00 | Immersion | 5 | None | A | A |
| 24 | LiNi_{1/3}Co1_{/3}Mn_{1/3}O₂ | Li-Naph/DME | 1.00 | Immersion | 10 | None | A | A |
| 25 | LiNi_{1/3}Co1_{/3}Mn_{1/3}O₂ | Li-Naph/DME | 1.00 | Immersion | 15 | None | A | A |
| 26 | LiNi13Co1_{/3}Mn_{1/3}O₂ | Li-Naph/DME | 1.00 | Immersion | 30 | None | A | B |
| 27 | LiNi_{1/3}Co1_{/3}Mn_{1/3}O₂ | Li-Naph/DME | 1.00 | Immersion | 45 | None | A | B |
| 28 | LiNi_{1/3}Co1_{/3}Mn_{1/3}O₂ | Li-Naph/DME | 1.00 | Immersion | 60 | None | A | B |
| 29 | LiNi_{1/3}Co1_{/3}Mn_{1/3}O₂ | Li-Naph/DME | 0.50 | Immersion | 5 | None | B | Not |
| | | | | | | | | yet |
| 30 | LiNi_{1/3}Co1_{/3}Mn_{1/3}O₂ | Li-Naph/DME | 0.50 | Immersion | 10 | None | B | Not |
| | | | | | | | | yet |
| 31 | LiNi_{1/3}Co1_{/3}Mn_{1/3}O₂ | Li-Naph/DME | 0.50 | Immersion | 45 | None | B | Not |
| | | | | | | | | yet |
| 32 | LiNi_{1/3}Co1_{/3}Mn_{1/3}O₂ | Li-Naph/DME | 0.50 | Immersion | 60 | None | B | Not |
| | | | | | | | | yet |
| 33 | LiNi_{1/3}Co1_{/3}Mn_{1/3}O₂ | Li-Naph/DME | 0.25 | Immersion | 5 | None | C | Not |
| | | | | | | | | yet |
| 34 | LiNi_{1/3}Co1_{/3}Mn_{1/3}O₂ | Li-Naph/DME | 0.25 | Immersion | 10 | None | C | Not |
| | | | | | | | | yet |
| 35 | LiNi_{1/3}Co1_{/3}Mn_{1/3}O₂ | Li-Naph/DME | 0.25 | Immersion | 15 | None | C | Not |
| | | | | | | | | yet |
| 36 | LiNi_{1/3}Co1_{/3}Mn_{1/3}O₂ | Li-Naph/DME | 0.25 | Immersion | 30 | None | C | Not |
| | | | | | | | | yet |
| 37 | LiNi_{1/3}Co1_{/3}Mn_{1/3}O₂ | Li-Naph/DME | 0.25 | Immersion | 45 | None | C | Not |
| | | | | | | | | yet |
| 38 | LiNi_{1/3}Co1_{/3}Mn_{1/3}O₂ | Li-Naph/DME | 0.25 | Immersion | 60 | None | C | Not |
| | | | | | | | | yet |
| 39 | LiNi_{1/3}Co1_{/3}Mn_{1/3}O₂ | Li-Naph/DME | 0.10 | Immersion | 5 | None | C | Not |
| | | | | | | | | yet |
| 40 | LiNi_{1/3}Co1_{/3}Mn_{1/3}O₂ | Li-Naph/DME | 0.10 | Immersion | 10 | None | C | Not |
| | | | | | | | | yet |
| 41 | LiNi_{1/3}Co1_{/3}Mn_{1/3}O₂ | Li-Naph/DME | 0.10 | Immersion | 15 | None | C | Not |
| | | | | | | | | yet |
| 42 | LiNi_{1/3}Co1_{/3}Mn_{1/3}O₂ | Li-Naph/DME | 0.10 | Immersion | 30 | None | C | Not |
| | | | | | | | | yet |
| 43 | LiNi_{1/3}Co1_{/3}Mn_{1/3}O₂ | Li-Naph/DME | 0.10 | Immersion | 45 | None | C | Not |
| | | | | | | | | yet |
| 44 | LiNi_{1/3}Co1_{/3}Mn_{1/3}O₂ | Li-Naph/DME | 0.10 | Immersion | 60 | None | C | Not |
| | | | | | | | | yet |

1) A: Complete peeling, B: 50% peeling, C: 20% peeling
2) A: The peak of a 003 plane of LiNi_{1/3}Co 1_{/3}Mn_{1/3}O₂ is found in the XRD pattern.
B: The peak of a 003 plane of LiNi_{1/3}Co 1_{/3}Mn_{1/3}O₂ is not found in the XRD pattern.

TABLE 3

| | | First treatment | | | | | | |
|---|---|---|---|---|---|---|---|---|
| | | Treatment | Li-Naph | Method for | Treatment | Second | 1) Peeled | 2) Crystal |
| Experimental | Active material | liquid | conc. | treating | time | treatment | state | state |
| Examples | — | — | mol/L | — | min. | — | — | — |
| 45 | LiFePO₄ | Li-Naph/DME | 1.00 | Immersion | 5 | Water | A | A |
| | | | | | | washing | | |
| 46 | LiFePO₄ | Li-Naph/DME | 1.00 | Immersion | 10 | Water | A | A |
| | | | | | | washing | | |
| 47 | LiFePO₄ | Li-Naph/DME | 1.00 | Immersion | 15 | Water | A | A |
| | | | | | | washing | | |
| 48 | LiFePO₄ | Li-Naph/DME | 1.00 | Immersion | 30 | Water | A | B |
| | | | | | | washing | | |
| 49 | LiFePO₄ | Li-Naph/DME | 1.00 | Immersion | 45 | Water | A | B |
| | | | | | | washing | | |
| 50 | LiFePO₄ | Li-Naph/DME | 1.00 | Immersion | 60 | Water | A | B |
| | | | | | | washing | | |

1) A: Complete peeling, B: 50% peeling, C: 20% peeling
2) A: The peak of a 111 plane of LifePO₄ is found in the XRD pattern.
B: The peak of a 111 plane of LifePO₄ is not found in the XRD pattern.

TABLE 4

| | | First treatment | | | | | | | |
|---|---|---|---|---|---|---|---|---|---|
| | | | | | | Amount of | | | |
| | | | Li- | Method | Amount | sprayed/ | | | |
| | | Treatment | Naph | for | of | Mass of | Second | 1) Peeled | 2) Crystal |
| Experimental | Active material | liquid | conc. | treating | sprayed | mixture | treatment | state | state |
| Examples | — | — | mol/L | — | mg | — | — | — | — |
| 51 | LiNi_{1/3}Co1_{/3}Mn_{1/3}O₂ | Li-Naph/THF | 1.00 | Spraying | 160 | 2.1 | Water | A | Not |
| | | | | | | | immersion | | yet |
| 52 | LiNi_{1/3}Co1_{/3}Mn_{1/3}O₂ | Li-Naph/THF | 1.00 | Spraying | 110 | 1.4 | Water | A | Not |
| | | | | | | | immersion | | yet |
| 53 | LiNi_{1/3}Co1_{/3}Mn_{1/3}O₂ | Li-Naph/THF | 1.00 | Spraying | 46 | 0.6 | Water | A | A |
| | | | | | | | immersion | | |

1) A: Complete peeling, B: 50% peeling, C: 20% peeling
2) A: The peak of a 003 plane of LiNi_{1/3}Co 1_{/3}Mn_{1/3}O₂is found in the XRD pattern.
B: The peak of a 003 plane of LiNi_{1/3}Co 1_{/3}Mn_{1/3}O₂ is not found in the XRD pattern.
Not yet: Not measured

TABLE 5

| | | First treatment + Second treatment | | | | | | First treatment only | | | | | |
|---|---|---|---|---|---|---|---|---|---|---|---|---|---|
| | | (Experimental Examples 1 to 22) | | | | | | (Experimental Examples 23 to 44) | | | | | |
| | | Treatment time of the first treatment | | | | | | Treatment time of the first treatment | | | | | |
| | | [min.] | | | | | | [min.] | | | | | |
| Peeled state | | 5 | 10 | 15 | 30 | 45 | 60 | 5 | 10 | 15 | 30 | 45 | 60 |
| Li-Naph conc. | 0.10 | A | A | A | A | A | A | C | C | C | C | C | C |
| [M] | 0.25 | A | A | A | A | A | A | C | C | C | C | C | C |
| | 0.50 | A | Not | Not | A | A | A | B | Not | Not | B | B | B |
| | | | yet | yet | | | | | yet | yet | | | |
| | 1.00 | A | A | A | A | A | A | A | A | A | A | A | A |

A: Complete peeling, B: 50% peeling, C: 20% peeling, Not yet: Not measured

TABLE 6

| | | First treatment + Second treatment | | | | | |
|---|---|---|---|---|---|---|---|
| | | (Experimental Examples 1 to 22) | | | | | |
| | | Treatment time of the first treatment | | | | | |
| | | [min.] | | | | | |
| Crystal state | | 5 | 10 | 15 | 30 | 45 | 60 |
| Li-Naph conc. | 0.10 | A | A | A | A | A | A |
| [M] | 0.25 | A | A | A | A | A | A |
| | 0.50 | A | Not | Not | A | A | B |
| | | | yet | yet | | | |
| | 1.00 | A | A | A | B | B | B |

A: The peak of a 003 plane of LiNi_{1/3}Co 1_{/3}Mn_{1/3}O₂ is found in the XRD pattern.
B: The peak of a 003 plane of LiNi_{1/3}Co 1_{/3}Mn_{1/3}O₂ is not found in the XRD pattern.

TABLE 7

| | | First treatment + Second treatment | | | | | |
|---|---|---|---|---|---|---|---|
| | | (Experimental Examples 45 to 50) | | | | | |
| | | Treatment time of the first treatment | | | | | |
| | | [min.] | | | | | |
| Crystal state | | 5 | 10 | 15 | 30 | 45 | 60 |
| Li-Naph conc. | 1.00 | A | A | A | B | B | B |
| [M] | | | | | | | |

A: The peak of a 111 plane of LifePO₄ is found in the XRD pattern.
B: The peak of a 111 plane of LifePO₄ is not found in the XRD pattern.

It goes without saying that the present disclosure is not limited to Examples described above and can be implemented in various aspects without departing from the technical scope of the present disclosure.

The present application claims priority based on Japanese Patent Application No. 2023-008046 filed Jan. 23, 2023, the entire contents of which are incorporated herein by reference.

### INDUSTRIAL APPLICABILITY

The present disclosure is applicable to the technical field of electricity storage devices.

### REFERENCE SIGNS LIST

10 treatment target electrode, 12 current collector, 14 positive electrode mixture, 16 electrode active material, 18 mixture member, 20 first treatment liquid, 25 second treatment liquid, 30 separation unit, 50 recovery system

1. A recovery method for recovering an electrode active material from a treatment target electrode including an electrode mixture containing the electrode active material and a binder, the recovery method comprising:
a separation step of bringing a first treatment liquid containing an aromatic hydrocarbon compound in a reduced state and a metal ion and a second treatment liquid containing water into contact with the treatment target electrode to separate the electrode active material from the treatment target electrode.

2. The recovery method according to claim 1, wherein, in the separation step, the second treatment liquid is brought into contact with the treatment target electrode in a state where the first treatment liquid is in contact with the treatment target electrode.

3. The recovery method according to claim 1, wherein, in the separation step, the first treatment liquid used has a concentration of the aromatic hydrocarbon compound in the reduced state of 0.1 mol/L or more and 0.5 mol/L or less.

4. The recovery method according to claim 1, wherein, in the separation step, a contact time during which the treatment target electrode is brought into contact with the first treatment liquid is 1 minute or more and 20 minutes or less.

5. The recovery method according to claim 1, wherein the binder contains a fluorine-containing polymer.

6. The recovery method according to claim 1, wherein the electrode active material is an oxide containing the metal ion.

7. The recovery method according to claim 1, wherein the aromatic hydrocarbon compound is at least one of compounds represented by formulas (1) and (2): 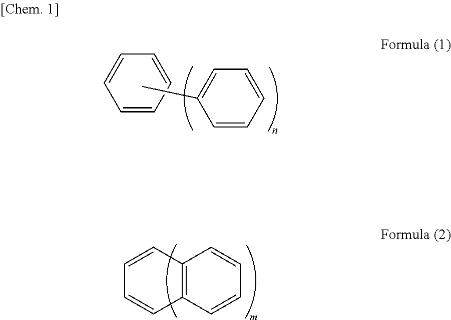
In the formulas, n is an integer of 1 or more and 4 or less, m is an integer of 1 or more and 4 or less, and these aromatic rings may each have a substituent or a heteroatom in its structure.

8. The recovery method according to claim 1, wherein the first treatment liquid contains at least one of dimethoxyethane (DME), tetrahydrofuran (THF), diethyl ether (DEE), diglyme (G2), triglyme (G3), and tetraglyme (G4).

9. A method for producing an electrode, comprising:
an electrode preparation step of preparing a new electrode using the electrode active material recovered by the recovery method according to claim 1.

10. A recovery system for recovering an electrode active material from a treatment target electrode including an electrode mixture containing the electrode active material and a binder, the recovery system comprising:
a separation unit configured to perform a separation treatment including bringing a first treatment liquid containing an aromatic hydrocarbon compound in a reduced state and a metal ion and a second treatment liquid containing water into contact with the treatment target electrode to separate the electrode active material from the treatment target electrode.
